(19) United States
(12) Patent Application Publication
(10) Pub. No.: US 2004/0218897 A1
(43) Pub. Date: Nov. 4, 2004

(54) AV system having a copyright protection function

(75) Inventors: Youichi Kudoh, Osaka (JP); Tadanobu Obayashi, Osaka (JP); Fumio Kanamaru, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ONKYO CORPORATION, Neyagawa-shi (JP)

(21) Appl. No.: 10/626,513

(22) Filed: Jul. 25, 2003

(30) Foreign Application Priority Data
Jul. 31, 2002 (JP) 2002-222669

(51) Int. Cl. H04N 5/76; H04N 5/781

(52) U.S. Cl. 386/46; 386/125

(57) ABSTRACT

An AV system that permits only a single copy of an AV content without encryption and prevents the copy from being further duplicated in order to protect the copyright is provided. The hard disk of a home server is divided into a secure system region and a non-secure user region. A PC searches for the home server to establish a connection for authentication. The PC includes a ripping unit and a reproducing unit. The network type audio apparatus also includes a reproducing unit and is authenticated. The ripping unit rips music data from a music CD after the authentication and duplicates the data in the system region. The reproducing unit reads out music data from the system region after the authentication and reproduces the music data by a streaming method.

### BACKGROUND OF THE INVENTION

1. Field of the Invention

The present invention relates to an AV (Audio/Video) system that records and reproduces sound such as music and/or video, and more specifically, to an AV system having a copyright protection function.

2. Description of the Related Art

In recent years, AV systems including a hard disk as a recording medium have been provided. For example, a hard disk recorder can store AV contents such as music and video in its hard disk and reproduce them when desired. A general personal computer (PC) can copy the data of a music CD (Compact Disk) in its hard disk using a CD ripper and reproduce the music when desired. However, the use of these devices does not always go together with the idea of copyright protections.

According to the SCMS (Serial Copy Management System), a single copy of an original content or a second-generation copy is permitted but copying of the second-generation copy, in other words, third-generation copying is not permitted. Therefore, an original content may be copied on a hard disk. The content copied on the hard disk (second-generation copy) however can easily be distributed to a great many unknown people: in other words, third-generation copies may be distributed widely through the Internet and the like.

A typical conventional method to preclude such unauthorized third-generation copies from being widely spread is to encrypt the content. The use of the encryption technique however not only complicates hardware and software for the devices themselves, but also make the devices far from user-friendly. Therefore, the devices incorporating the encryption technique are not likely to be widely used.

### SUMMARY OF THE INVENTION

It is a main object of the present invention to provide an AV system having a copyright protecting function.

Another object of the invention is to provide an AV system that can provide copyright protections for AV contents by a simple method without encrypting the contents.

Yet another object of the invention is to provide an AV system that permits only a single copy of an AV content and prevents further copying of the single copy.

The AV system according to the invention includes a storage device, an authenticator, a writer, and a reproducer. The storage device has a secure storage region. The authenticator determines whether or not to permit data to be written in the secure storage region and whether or not to permit data to be read out from the secure storage region. The writer writes the data in the secure storage region when the authenticator permits the data to be written in the region. The reproducer reads out the data from the secure storage region when the authenticator permits the data to be read out and reproduces sound and/or video based on the data.

By this AV system, data is written in the secure storage region only when permission to write the data is given. Therefore, AV contents such as sound and video are duplicated in the secure storage region, so that third-generation copying of the copy can be prevented. Data is read out only when permission to read out the data is given, so that the sound and video can be reproduced based on the copy. Consequently, the copyright of the sound or video can be protected.

The writer preferably rips data from a medium (such as music CD) having the data stored therein and writes the data in the secure storage region.

The reproducers preferably reproduces sound and/or video by a streaming method.

In this case, the sound and/or video is reproduced while the data is read out, so that the data can be prevented from being downloaded and made into third-generation copies.

The foregoing and other objects, features, aspects, and advantages of the present invention will become more apparent from the following detailed description of the present invention when taken in conjunction with-the accompanying drawings.

### BRIEF DESCRIPTION OF THE DRAWINGS

FIG. 1 is a functional block diagram of the configuration of an audio system as a whole according to an embodiment of the invention;

FIG. 2 is a diagram of the directory structure in the hard disk of the home server in FIG. 1;

FIG. 3 is a flowchart for use in illustration of authentication processing by the audio system in FIG. 1;

FIG. 4 is a flowchart for use in illustration of ripping processing by the audio system shown in FIG. 1; and

FIG. 5 is a flowchart for use in illustration of reproducing processing by the audio system shown in FIG. 1.

### DETAILED DESCRIPTION OF THE PREFERRED EMBODIMENTS

Now, an embodiment of the invention will be described in detail in conjunction with the accompanying drawings, in which the same or corresponding units are denoted by the same reference characters, and description about them is not repeated.

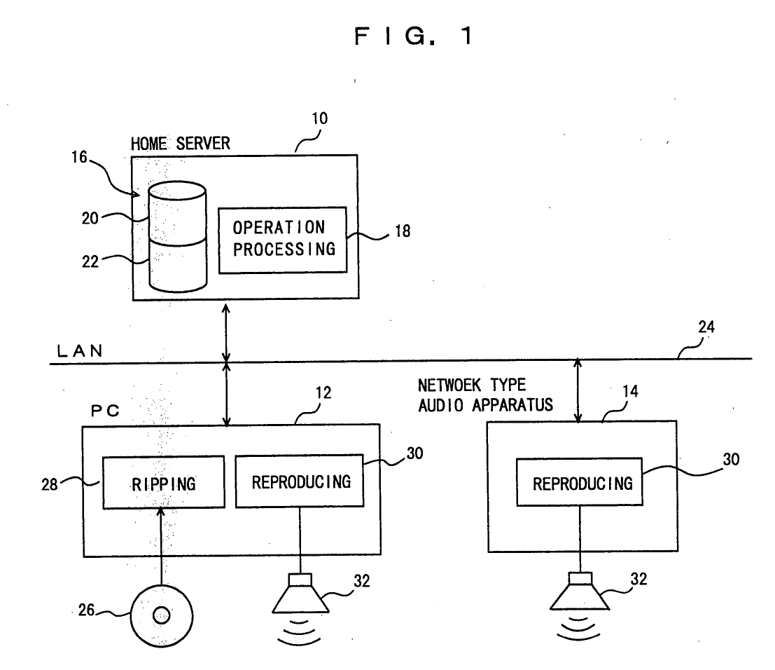

Referring to FIG. 1, an audio system according to the embodiment includes a home server 10, a PC 12, and a network type audio apparatus 14.

The home server 10 has a mass storage hard disk 16 and an operation processing unit 18 such as a CPU. The hard disk 16 is divided into a system region 20 as a secure storage region and a user region 22 as a non-secure storage region. Only the system of the home server 10 itself or privileged users can access the system region 20, while general users can access the user region 22. The system region 20 stores system files and music data that needs copyright protections. The music data may be in various formats such as MP3, WMA, and PCM, but the data is not encrypted. Meanwhile, the user region 22 stores data such as data recorded from the TV, family photos, and an address book that can be precluded from copyright protections.

The PC 12 is connected to the home server 10 via a LAN 24 and functions as a client to the home server 10. An AV content recording/reproducing program that is dedicated application software is installed in the PC 12. Once the software is installed, the PC 12 has a ripping unit 28 that extracts music data from a music CD 26 and copies the data on the hard disk 16 of the home server 10, and a reproducing unit 30 that obtains music data from the home server 10 and reproduces the music. The reproducing unit 30 can obtain music data from the home server 10, decode compressed music data, and D-A (digital-analog) convert music data. The reproducing unit 30 drives a speaker 32 that outputs reproduced music.

The network type audio apparatus 14 is also connected to the home server 10 via the LAN 24 and functions as a client to the home server 10. A reproducing program that is dedicated application software is installed in the network type audio apparatus 14. Once the program is installed, the audio apparatus 14 also has the reproducing unit 30 similarly to the PC 12 but does not have the ripping unit 28 unlike the PC 12.

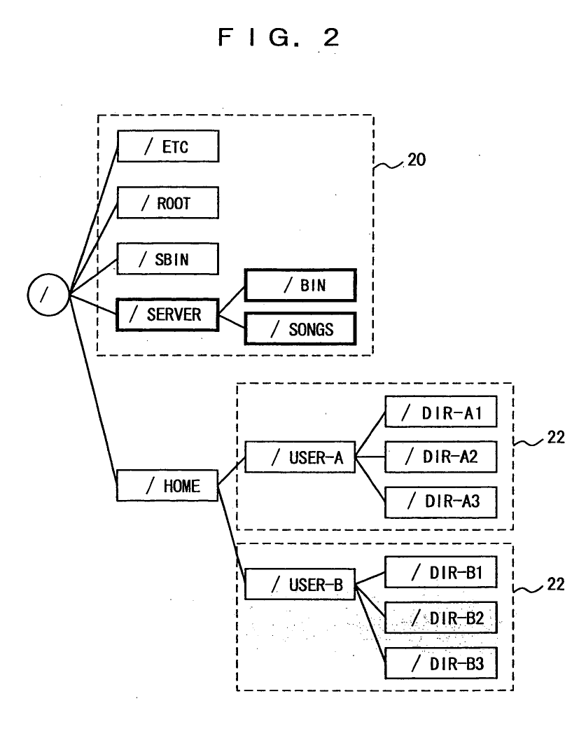

FIG. 2 shows the directory structure of the hard disk 16 in the home server 10.

The hard disk 16 includes a directory /server. The directory /server includes directories /bin and /songs. The directories /server, /bin, and /songs are formed in the system region 20. Programs for enabling the home server 10 to authenticate a client (such as the PC 12 and the network type audio apparatus 14) and respond to ripping and reproducing are recorded in the directory /bin. A large number of music data pieces ripped from the music CD 26 are recorded in the directory /songs. Only the PC 12 and the network type audio apparatus 14 can access the directories /server, /bin, and /songs.

The hard disk 16 further includes a directory /home. The directory /home includes directories /user-A and /user-B. The directory /user-A includes directories /dir-A1, /dir-A2, /dir-A3, etc. The directories /user-A, and /dir-A1˜/dir-A3 are formed in the user region 22 for the user A. The directories /user-A, and /dir-A1˜/dir-A3 can only be accessed by the user A. The directory /user-B includes directories /dir-B1, /dir-B2, /dir-B3, etc. The directories /user-B, and /dir-B1˜/dir-B3 are formed in the user region 22 for the user B. The directories /user-B, and /dir-B1˜/dir-B3 can only be accessed by the user B.

Now, the operation of the above-described audio system will be described.

Authentication Processing

The audio system carries out authentication processing between the home server 10 and the PC 12 or between the home server 10 and the network type audio apparatus 14 before ripping or reproducing processing that will be described. The authentication processing is the same for the PC 12 and the network type audio apparatus 14, and therefore the processing for the PC 12 will be described by way of illustration.

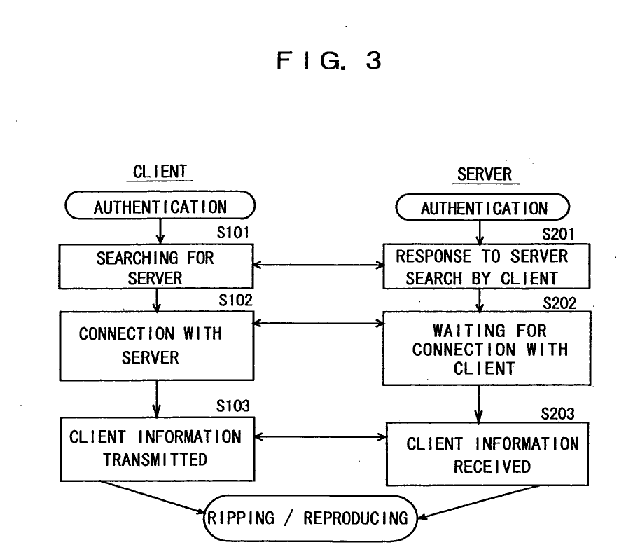

Referring to FIG. 3, when an AV content recording/reproducing program is activated in the PC 12 (or when the power supply is turned on and the AV content reproducing program is activated in the network type audio apparatus 14), the PC 12 searches for an active server on the LAN 24 (S101). More specifically, the PC 12 broadcasts a predetermined magic word on the LAN 24 (S101). If in an active state, the home server 10 returns the magic word as it is to the PC 12 and transmits its IP address and port number to the PC 12 (S201).

Then, the PC 12 requests the home server 10 to establish a necessary connection for transmitting/receiving a command and a status based on the received IP address and port number of the home server 10 (S102). The home server 10 accepts the request and establishes the connection with the PC 12 (S202).

The PC 12 then transmits its client information to the home server 10 (S103). The client information includes a flag indicating the presence/absence of a connection, a client type indicating the client kind (the PC 12, the network type audio apparatus 14, etc.), and the present status of the client. The home server 10 receives the client information (S203) and stores the information in a database in order to manage the clients such as the PC 12 and the network type audio apparatus 14.

In this manner, the home server 10 authenticates the PC 12. The PC 12 can carry out ripping or reproducing processing, that will be described, only when it is authenticated by the home server 10.

In the same manner, the home server 10 authenticates the network type audio apparatus 14. The network type audio apparatus 14 can also carry out reproducing processing, that will be described, only when it is authenticated by the home server 10.

Ripping Processing

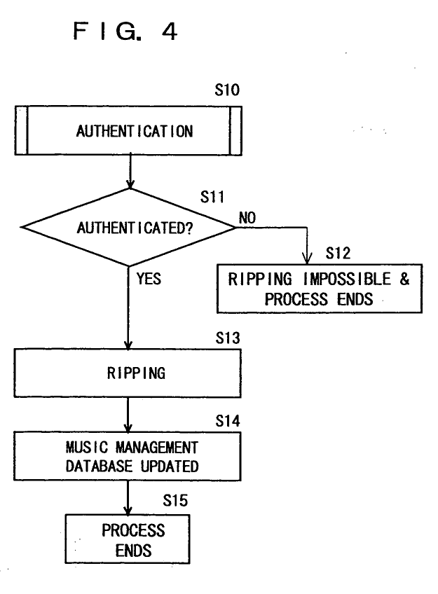

Referring to FIG. 4, the PC 12 carries out the above authentication processing before carrying out the ripping processing that will be described (S10). The PC 12 then determines whether or not the authentication is successful (S11). If the authentication is not successful, the user will be informed of the impossibility of ripping, and the process ends (S12).

Meanwhile, if the authentication is successful, the PC 12 carries out the ripping processing (S13). More specifically, the ripping unit 28 reads out music data from the music CD 26 and writes the data in the hard disk 16 of the home server 10. The music data is directly stored in the hard disk 16 of the home server 10, not in the hard disk of the PC 12. The music data is stored in the directory /songs in the system region 20, not in the user region 22.

When the PC 12 finishes ripping data from the music CD 26 and storing the data in the home server 10, the home server 10 updates a music management database based on the new music data (S14). The music management database is used to manage music data stored in the hard disk 16. In order to rip a plurality of music pieces, the above steps S13 and S14 are repeated.

The PC 12 carries out the ripping as described above, and then the process ends (S15).

Reproducing Processing

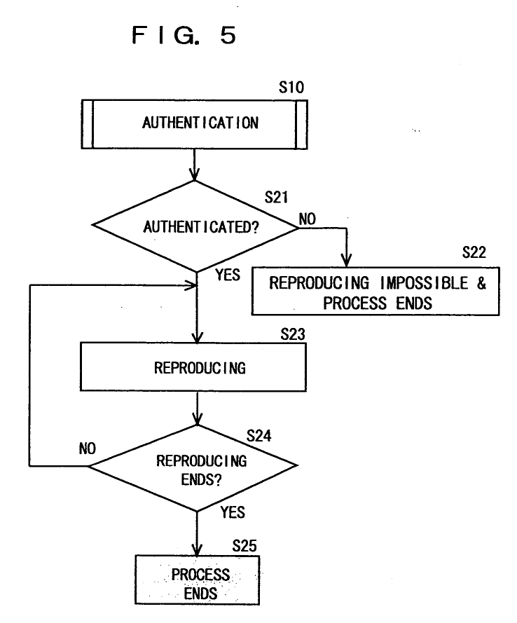

Referring to FIG. 5, the PC 12 also carries out the authentication processing described above before reproducing processing that will be described (S10). Then, the PC 12 determines whether or not the authentication is successful (S21). If the authentication is not successful, the user will be informed of the impossibility of reproducing, and the process ends (S22).

Meanwhile, if the authentication is successful, the PC 12 carries out the reproducing processing (S23). More specifically, the reproducing unit 30 reads out music data from the hard disk 16 of the home server 10 and reproduces the music based on the music data. The reproducing here is carried out by a streaming method: in other words, the music is reproduced while the data for the music is read out. Therefore, the data of a single music piece as a whole is not downloaded to the hard disk 16 of the PC 12.

The PC 12 repeats the reproducing processing described above until the reproducing is over (S24), and once the reproducing is over, the process ends (S25).

The network type audio apparatus 14 carries out the reproducing processing in the same manner.

The programs necessary for enabling the computer to carry out these steps have been installed in the home server 10, the PC 12, and the network type audio apparatus 14. These programs can be distributed as they are recorded in a computer-readable storage medium such as a CD-ROM, while the programs can directly be distributed over an electrical communication line such as the Internet rather than being once stored in the storage medium.

As in the foregoing, according to the embodiment, the PC 12 authenticated by the home server 10 can access the system region 20 that can not be accessed by a general user, and therefore music data can be ripped from the music CD 26 and duplicated in the system region 20. Since the music data is duplicated in the system region 20, third-generation copying of the music data cannot be carried out by other PCs that are not authenticated by the home server 10. The PC 12 or the network type audio apparatus 14 authenticated by the home server 10 can access the system region 20, and therefore can read out the music data from the system region 20 to reproduce the music. Since the PC 12 or the network type audio apparatus 14 reproduces the music data read out by the streaming method, the music data cannot be downloaded and produced into third-generation copies. The audio system carries out the authentication by a unique protocol and distributes the music data, and therefore the music data presently being distributed cannot be unlawfully ripped for producing third-generation copies. In this way, the audio system cannot produce third-generation copies, and therefore the copyright of the music CD 26 can be protected.

This audio system can save the music data in the home server 10 without encrypting the data and distribute the data to the PC 12 or the network type audio apparatus 14, so that complicated hardware or software is not necessary.

According to the embodiment, the audio system is made up of a server-client system including the home server 10 and the PC 12, while the system may be in a stand-alone structure including only the PC 12. In this case, the PC 12 copies music data ripped from the music CD 26 in the system region of its local hard disk, not in the hard disk 16 of the home server 10, and reads out and reproduces the copied music data. Also in this case, only the authenticated AV content recording/reproducing program can access the system region.

According to the embodiment described above, the PC 12 rips music data from the music CD 26 and stores the data directly in the hard disk 16 of the home server 10. Meanwhile, the ripped data may be stored in its hard disk (local hard disk) and then transferred to the hard disk 16 of the home server 10. In this case, the PC 12 removes the music data on the hard disk of the PC 12 to the hard disk 16 of the home server 10 rather than copying the data thereto. In the other words, the music data no longer exists on the hard disk of the PC 12 after the ripping.

According to the embodiment, music data is ripped from the music CD, while such music data may be downloaded from a music distribution site on the Internet and saved in the system region.

According to the embodiment, the PC 12 includes both the ripping unit 28 and the reproducing unit 30, but the PC 12 may include only one of them. The PC including only the reproducing unit 30 functions in the same manner as the network type audio apparatus 14 does.

The embodiment is directed to the audio system that reproduces music contents, but the present invention may be applied to AV systems that reproduce visual contents.

Although the present invention has been described and illustrated in detail, it is clearly understood that the same is by way of illustration and example only and is not to be taken by way of limitation. The invention may be embodied in various modified forms without departing from the spirit and scope of the invention.

What is claimed is:

1. An AV system, comprising:
a storage device having a secure storage region;
an authenticator determining whether or not to permit data to be written in said secure storage region and whether or not to permit data to be read out from said secure storage region;
a writer writing said data in said secure storage region when said authenticator permits said data to be written in the region; and
a reproducer reading out said data from said secure storage region when said authenticator permits said data to be read out and reproducing sound and/or video based on said data.

2. The AV system according to claim 1, wherein
said writer rips said data from a medium having said data recorded therein and writes said data in said secure storage region.

3. The AV system according to claim 1, wherein
said reproducer reproduces sound and/or video by a streaming method.

4. A method of recording/reproducing an AV content, comprising the steps of:
determining whether or not to permit data to be written in a secure storage region and whether or not to permit data to be read out from said secure storage region;
writing said data in said secure storage region when the permission to write said data is given; and
reading out said data from said secure storage region and reproducing sound and/or video based on said data when the permission to read out said data is given.

5. An AV content recording/reproducing program product for enabling a computer to execute the steps of:
determining whether or not to permit data to be written in a secure storage region and whether or not to permit data to be read out from said secure storage region;
writing said data in said secure storage region when the permission to write said data is given; and
reading out said data from said secure storage region and reproducing sound and/or video based on said data when the permission to read out said data is given.

6. An AV apparatus, comprising:
an authenticator requesting permission to read out data from a secure storage region; and
a reproducer reading out said data from said secure storage region when the permission to read out said data is given and reproducing sound and/or video based on said data.

7. An AV apparatus, comprising:
an authenticator requesting permission to write data in a secure storage region; and
a writer writing said data in said secure storage region when the permission to write said data is given.

8. An AV system, comprising a server, and a client connected to said server through a network,
said server comprising:
a storage device having a secure storage region; and
an authenticator authenticating said client,
said client comprising:
a reproducer reading out data from said secure storage region when the client is authenticated by said authenticator and reproducing sound and/or video based on said data.
